(19) United States
(12) Patent Application Publication
(10) Pub. No.: US 2017/0083185 A1
(43) Pub. Date: Mar. 23, 2017

(54) SYSTEMS AND METHODS FOR INPUT PROCESSING OF A DEVICE

(71) Applicant: Dennis Huang, Campbell, CA (US)

(72) Inventor: Dennis Huang, Campbell, CA (US)

(21) Appl. No.: 15/267,480

(22) Filed: Sep. 16, 2016

Related U.S. Application Data
(60) Provisional application No. 62/220,969, filed on Sep. 19, 2015.

(51) Int. Cl. G06F 3/0482; G06F 3/0484; G06F 3/01; G06F 3/0488

(52) U.S. Cl. CPC G06F 3/0482; G06F 3/04883; G06F 3/04847; G06F 3/013

(57) ABSTRACT

Example implementations described herein are directed to implementing a transition state between the moving state and the placement state of the graphical object. The transition state contains a visual indicator on the display to indicate that a graphical object is undergoing a placement, along with a temporal indicator to indicate length of time until placement. During the transition phase, input is directed by the GUI towards control of the graphical object in the transition state, whereupon when the graphical object is moved away from the placement location, the transition state may reset, and the temporal indicator may also reset to indicate the refreshed length of time until placement.

### CROSS-REFERENCE TO RELATED APPLICATIONS

This U.S. patent application is based on and claims the benefit of domestic priority under 35 U.S.C. 119(e) from provisional U.S. patent application No. 62/220,969, filed on Sep. 19, 2015, the disclosure of which is hereby incorporated by reference herein in its entirety.

### BACKGROUND

Field

The present disclosure relates generally to input processing for devices, and more specifically, to input processing of graphical object placement within a graphical user interface of a device.

Related Art

In the related art, devices having graphical user interfaces (GUI) can receive input for placement of graphical objects within the interface. Such operations can include drag and drop, moving of an object through a keyboard interface, moving an object through a touch screen interface and so on. Such devices can involve various input methods such as gesture through touch screen, stylus, game controller or other remote controller, keyboard, mouse, headset with controller, free space gestures involving glasses, buttons, and so on.

In certain types of GUI for facilitating games in the related art, graphical objects may have two operating states, the moving state (i.e. graphical object is moving) and the placement state (i.e. graphical object is set in place). In such interfaces in the related art, the change from the moving state to the placement state is indicated by use of an audio cue, which indicates that the graphical object is set in place. Upon placement of the graphical object, the GUI automatically directs input to a different graphical object.

FIG. 1(a) illustrates the state diagram of a GUI. There is a moving state 101 where input made to the GUI is used to control a graphical object. There is a placement state 102, where once the object is placed, an audio cue is provided to indicate that placement of the graphical object is complete, whereupon the GUI selects another graphical object for control in the movement state 101, and transitions back to the movement state 101.

### SUMMARY

In such related art implementations, the user may be unable to determine when the graphical object is in the moving state or in the placement state. In hardware implementations of the GUI of present day, audio cues may be missed depending on the implementation of the interface. For example, a mobile phone or a tablet facilitating such a user interface may be set on mute, thereby disabling audio and preventing the user from hearing the audio cues. In another hardware implementation example, the visual display of the device may be fed into a splitter, which facilitates the visual display across multiple display screens. Should a user or a plurality of users be utilizing the interface through the multiple display screens, audio may not be available for all of the displays depending on the configuration of the hardware implementation. Thus, the user of the interface may misjudge whether the graphical object is in the moving state or the placement state due to the lack of the audio cue, which may provoke unintended input during the moving state or the placement state when the user is mistaken as to the state of the graphical object. For example, the user may believe that the graphical object is placed while it is instead in the moving state, and may make input intended for another graphical object when the GUI has not yet configured input to be automatically directed to another graphical object due to the graphical object being in the moving state. Such unintended input may thereby move the graphical object to a location different from what the user intended.

Further, the graphical objects may be moving in high speed, wherein the transitions between the moving state and the placing state may occur very quickly. The user may not be able to enter the intended input for the intended graphical object due to the high speed of the transition changes.

Further, the user interface may be in the form of an augmented reality (AR) or virtual reality (VR), where precise placement of the AR apparatus or VR apparatus is required to select the AR or VR object. In some circumstances, the user may not wish to select a particular AR or VR object, but the object ends up being selected due to the orientation of the AR or VR apparatus. In other circumstances, the user may wish to select a particular AR or VR object, but cannot focus the object into view with the VR or AR apparatus to select the object, due to the imprecision or difficulty in utilizing the equipment of the AR or VR (e.g., glasses, controller with headset, finger or stylus on screen with limited space incurring a fat finger problem, etc.) in selecting particular pixels from a user point of view.

Further, the user interface may be in the form of a free space implementation, where the graphical objects are in free space (e.g. 3D projections, holographic displays, holograms). In some circumstances, it may be difficult to know where the cursor is located in free space, thereby making it difficult to confirm the selection or movement of graphical objects through such an interface.

Further, it may be difficult to place a moving cursor onto a desired target object, depending on the equipment used. In an example involving a mouse, a remote controller (e.g. game console remote, remote controller, etc.), VR remote, free space gesture, or AR stylus, the selection area of a particular object may only span a few pixels or an ambiguous area in free space, thereby making selection of the object to be difficult. In another example, movement of a cursor on a display screen of a mobile device for an AR implementation may be difficult as a particular object may only span a few pixels, and it can be difficult to utilize a stylus or finger to make a gesture or selection on a desired portion of the display screen due to the fat finger problem. In another example implementation, there may be many static objects on the screen, some of which may be selectable and some of which may not be selectable, so that it can be confusing as to where a mouse cursor is displaced or whether a particular object is selectable. In another example implementation, a cursor in a VR setting controlled by a gesture in free space or a controller may be difficult to place due to the difference between what the user sees in the VR interface (e.g. glasses, headset), versus the actual placement of the cursor. In such example implementations, there is provided an indication such as a timer when a moving cursor is placed to rest over an object, whereupon the control set is configured to change so that the user is aware that the cursor is in the process of selecting or otherwise manipulating a particular object.

Aspects of the present disclosure may include a method for a graphical user interface (GUI), which may involve displaying a visual indicator indicative of time remaining until placement of a previously moving graphical object; changing an input set of the GUI from a first set of inputs to a second set of inputs; processing one or more inputs directed at the previously moving graphical object based on the second set of inputs; for either one of expiration of the time remaining or for an input indicating placement of the graphical object according to the second set of inputs, setting the graphical object in place and changing the input set from the second set of inputs to the first set of inputs; and for input indicative of movement according to the second set of inputs, moving the previously moving graphical object according to a limited motion ruleset.

Aspects of the present disclosure may include a non-transitory computer readable medium storing instructions for a graphical user interface (GUI), which may involve displaying a visual indicator indicative of time remaining until placement of a previously moving graphical object; changing an input set of the GUI from a first set of inputs to a second set of inputs; processing one or more inputs directed at the previously moving graphical object based on the second set of inputs; for either one of expiration of the time remaining or for an input indicating placement of the graphical object according to the second set of inputs, setting the graphical object in place and changing the input set from the second set of inputs to the first set of inputs; and for input indicative of movement according to the second set of inputs, moving the previously moving graphical object according to a limited motion ruleset.

Aspects of the present disclosure may further include an apparatus, which may involve a processor, configured to display a visual indicator indicative of time remaining until placement of a previously moving graphical object; change an input set of the Graphical User Interface (GUI) from a first set of inputs to a second set of inputs; process one or more inputs directed at the previously moving graphical object based on the second set of inputs; for either one of expiration of the time remaining or for an input indicating placement of the graphical object according to the second set of inputs, set the graphical object in place and change the input set from the second set of inputs to the first set of inputs; for input indicative of movement according to the second set of inputs, move the previously moving graphical object according to a limited motion ruleset.

Aspects of the present disclosure further include a non-transitory computer readable medium, storing instructions for executing a process, which can include instructions for displaying a visual indicator indicative of time remaining until selection of an object by a cursor; changing an input set of a graphical user interface (GUI) from a first set of inputs to a second set of inputs; processing one or more inputs directed at the object based on the second set of inputs; for either one of expiration of the time remaining or for an input indicating selection of the object according to the second set of inputs, invoking a command at the graphical object and changing the input set from the second set of inputs to the first set of inputs; and for input indicative of movement according to the second set of inputs, moving the cursor according to a motion ruleset.

Aspects of the present disclosure further include a method which can include displaying a visual indicator indicative of time remaining until selection of an object by a cursor; changing an input set of a graphical user interface (GUI) from a first set of inputs to a second set of inputs; processing one or more inputs directed at the object based on the second set of inputs; for either one of expiration of the time remaining or for an input indicating selection of the object according to the second set of inputs, invoking a command at the graphical object and changing the input set from the second set of inputs to the first set of inputs; and for input indicative of movement according to the second set of inputs, moving the cursor according to a motion ruleset.

Aspects of the present disclosure further include an apparatus, which can include means for displaying a visual indicator indicative of time remaining until selection of an object by a cursor; means for changing an input set of a graphical user interface (GUI) from a first set of inputs to a second set of inputs; means for processing one or more inputs directed at the object based on the second set of inputs; for either one of expiration of the time remaining or for an input indicating selection of the object according to the second set of inputs, means for invoking a command at the graphical object and changing the input set from the second set of inputs to the first set of inputs; and for input indicative of movement according to the second set of inputs, means for moving the cursor according to a motion ruleset.

### BRIEF DESCRIPTION OF THE DRAWINGS

FIG. 1(a) illustrates an example state diagram of a related art GUI.

FIG. 1(b) illustrates an example state diagram of a GUI, in accordance with an example implementation.

FIG. 2(a) illustrates an example game screen with the GUI set on the moving state, in accordance with an example implementation.

FIG. 2(b) illustrates an example game screen with the GUI set in the transition state, in accordance with an example implementation.

FIG. 2(c) illustrates an example game screen with the GUI set on the transition state 112, in accordance with an example implementation.

FIG. 3(a) illustrates example controls for a GUI during the moving state, in accordance with an example implementation.

FIG. 3(b) illustrates example controls for a GUI during the transition state, in accordance with an example implementation.

FIGS. 4(a) and 4(b) illustrates an example movement of graphical objects for a touch screen in accordance with an example implementation.

FIG. 5(a) illustrates the flow diagram for a moving state, in accordance with an example implementation.

FIG. 5(b) illustrates the flow diagram for a transition state, in accordance with an example implementation.

FIG. 5(c) illustrates the flow diagram for the placement state, in accordance with an example implementation.

FIG. 6 illustrates an example computer diagram upon which example implementations may be implemented.

FIGS. 7(a) to 7(c) illustrate an example movement of graphical objects for an AR/VR system, in accordance with an example implementation.

FIGS. 8(a) to 8(c) illustrate an example cursor implementation through the use of a controller or other selection means.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application.

Example implementations of the present disclosure are directed to providing a transition state interposed between the moving state and the placement state for a controlled graphical object. During the transition state, the GUI may facilitate different input controls than in the moving state and the placement state to ensure that the user desired movement of the graphical object is implemented.

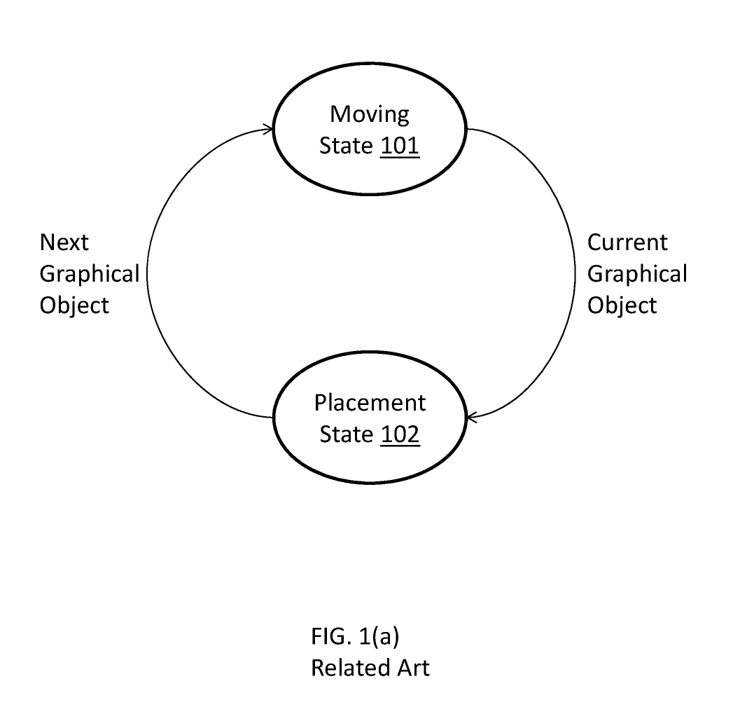

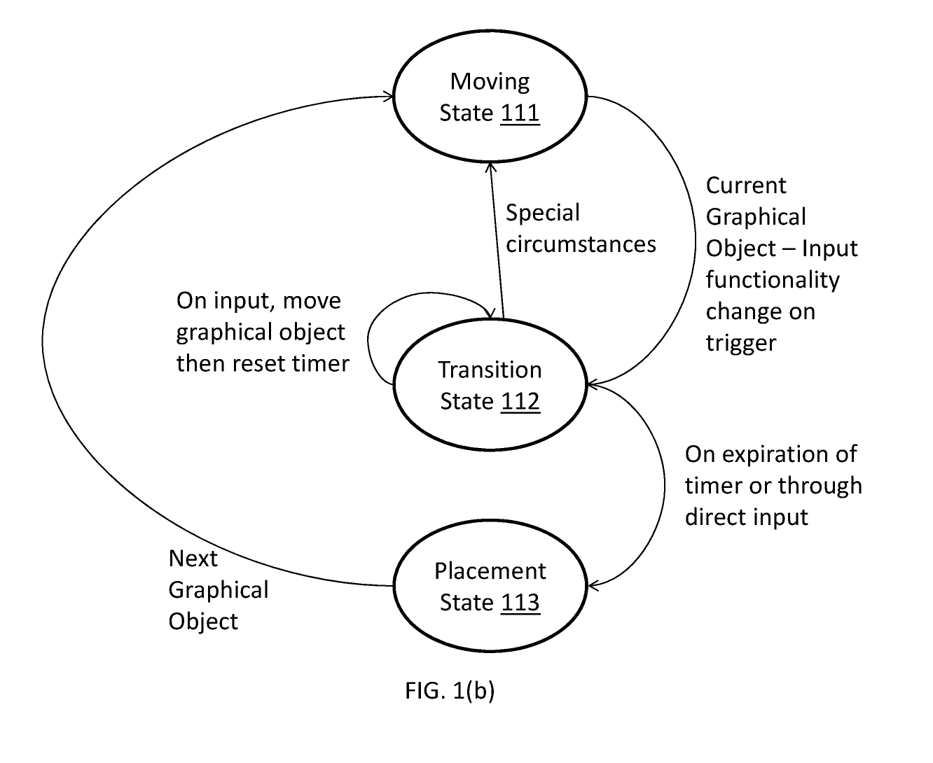

FIG. 1(b) illustrates the state diagram of a GUI, in accordance with an example implementation. There is a moving state 111 where input made to the GUI is used to control a graphical object. There is a placement state 113, where once the object is placed, the GUI selects another graphical object for control in the movement state 101, and transitions back to the movement state 101. Interposed between the moving state 111 and the placement state 113 is the transition state 112, which provides notice to the user that the graphical object is undergoing a transition to the placement state 113.

In the moving state 111, functionality may be implemented similarly to moving state 101 of FIG. 1(a). However, the moving state 111 transitions to the transition state 112 upon some trigger event (e.g., graphical object is dropped, can no longer move in the direction it was previously moving, abuts another graphical object, abuts the end of the permitted movement space of the GUI, expiration of a timer after the graphical object is moved into a particular location, etc.). During the moving state 111, the GUI facilitates an input set directed to the moving state 111 which allows the user to move the graphical object.

In the transition state 112, the graphical object is transitioning from movement to final placement. During the transition state 112, a visual indicator can be utilized on the display to indicate that the graphical object is in the transition state 112. When the graphical object changes from the transition state 112 to the placement state 113, the visual indicator may be removed or changed to indicate that the graphical object is in the placement state 113. The transition from the transition state 112 to the placement state 113 may be caused by a trigger such as direct input to the GUI to put the graphical object into the placement state 113, or expiration of time allotted by the implementation to permit the graphic object to remain in the transition state 112. Depending on the desired implementation, the visual indicator can also indicate the time remaining for the graphical object to remain in the transition state 112.

During the transition state 112, the GUI is configured to provide different functionality from the moving state 111 to allow for a user input provoked transition to the placement state 113, as well as for limited movement of the graphical object during the transition state. The limited movement can be determined according to a limited motion ruleset that restricts the movement (e.g., allow only lateral movement while adjacent to another graphical object, allow only certain types of rotation, etc.). Examples of input to the GUI to provoke the placement state 113 can include a movement input to push the graphical object into another graphical object, into the boundaries of the permitted movement space of the GUI, or a direct input such as a mouse click or touch gesture bound to transitioning the graphical object directly to the placement state, depending on the desired implementation.

When an input for movement is detected by the GUI during the transition state 112, the GUI can be configured to move the graphical object according to the input. In example implementations, the expiration timer of the transition state 112 can be reset upon movement of the graphical object during the transition state 112. In example implementations, the visual indicator can be changed to indicate that the timer is reset, and the transition state 112 has restarted. The timer can also be reset upon exit of the transition state in example implementations, to reset the time for the next graphical object that enters the transition state 112.

To prevent perpetual movement of the graphical object during the transition state 112, the number of movements during the transition state 112 can be limited to a threshold according to the desired implementation. Once the threshold has been reached or exceeded, example implementations may directly transition the graphical object to the placement state 113, or can continue in the transition state 112 while denying all input other than the input directly transitioning the graphical object to the placement state 113, depending on the desired implementation. Further restriction of movement input to the graphical object during the transition state 112 can include preventing the graphical object from moving in a particular direction (e.g., opposite from where it was previously moving), restriction of the graphical object to rotation in place only, restriction to lateral movement along a single axis, and so on, restriction on permitted rotational movement, and so on, depending on the desired implementation.

In the transition state 112, there can also be special circumstances where the GUI transitions back to the moving state 111 for the graphical object, depending on the desired implementation. Examples of such special circumstances are when the lateral movement or rotation of the graphical object allows the graphical object to proceed with movement in a direction without obstruction, thereby rendering the limited motion ruleset to not be applicable. Other examples of special circumstances where the limited motion ruleset is no longer applicable can include an opening in the game screen to facilitate movement, or other desired implementations.

During the placement state 113, the graphical object is set in place and then the GUI selects another graphical object and transitions back to the moving state 111 to change the GUI input set to facilitate the input functions of the moving state 111 for the selected another graphical object. In desired implementations where a subsequent graphical object is not selected (e.g., clearance of a game level, editing of icons in a GUI, GUI facilitating icon rearrangement, etc), the GUI may be configured to not return to the moving state 111 and can execute another function in accordance with the desired implementation.

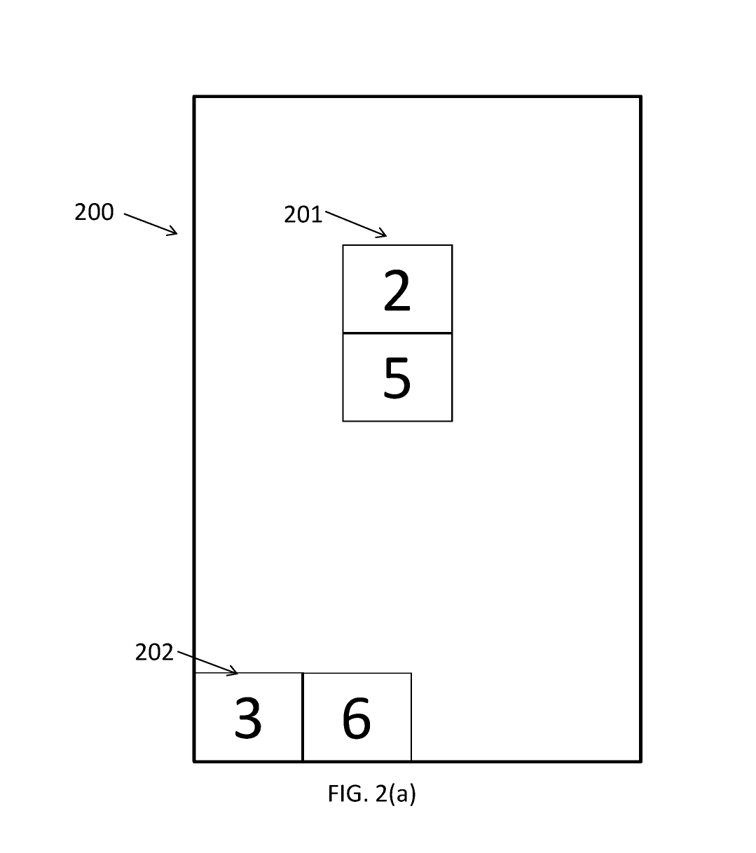

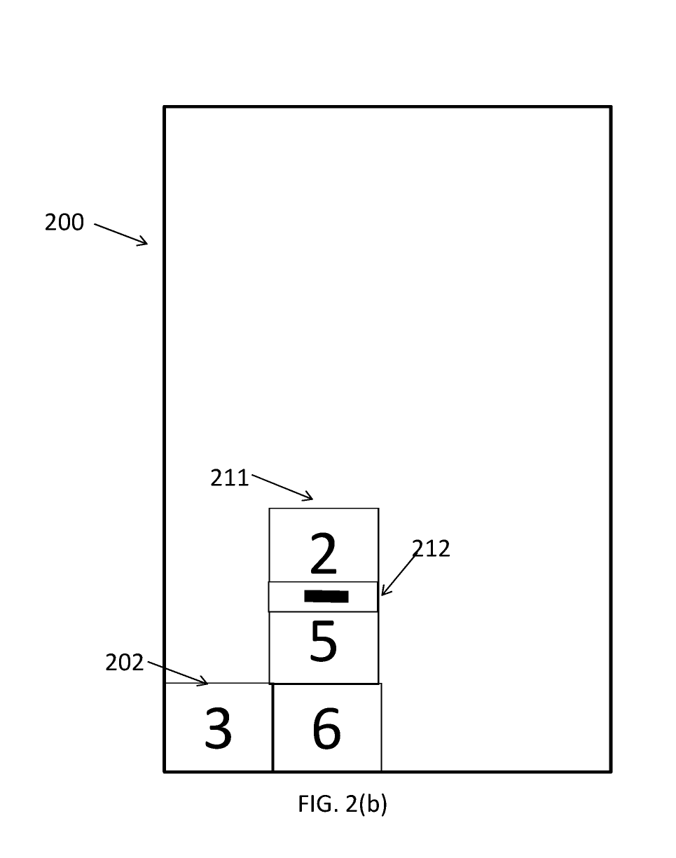

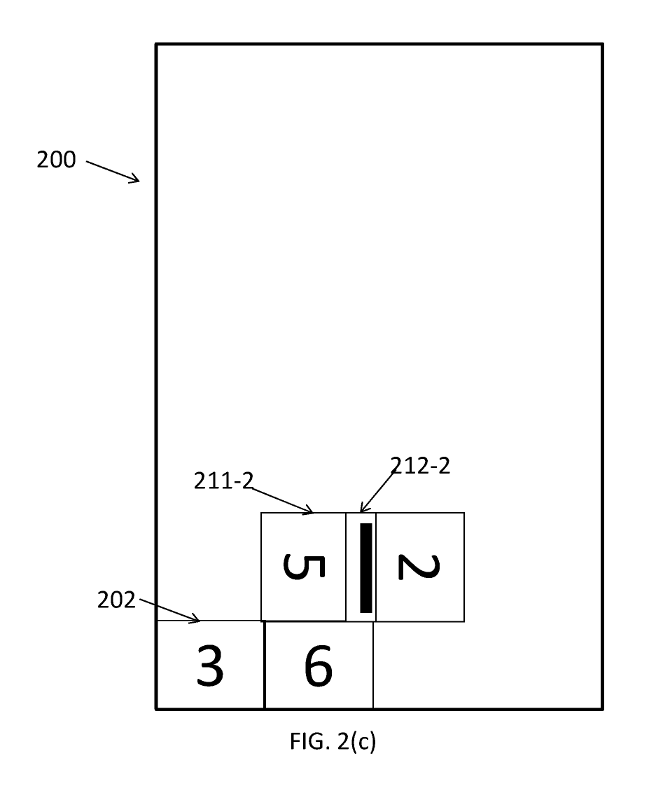

FIG. 2(a) illustrates an example game screen with the GUI set on the moving state 111, in accordance with an example implementation. In the example game screen 200, the GUI is set at the moving state 111, with the graphical object 201 selected to move. Graphical object 202 was previously placed from an earlier transition to the placement state 112 of the GUI. Thus, while the GUI is set on the moving state 111, the graphical object 201 may be moved based on inputs provided to the apparatus facilitating the GUI while graphical object 201 is selected.

FIG. 2(b) illustrates an example game screen with the GUI set on the transition state 112, in accordance with an example implementation. In the example game screen 200, the GUI is set at the transition state 112, with the graphical object 211 selected as the transition. Graphical object 202 was previously placed from an earlier transition to the placement state 112 of the GUI. Thus, while the GUI is set on the transition state 112, the GUI may accept limited inputs for the movement of graphical object 211. In the example implementation as illustrated in FIG. 2(b), such limited movements can include rotation, or limited lateral movement, however, the allowed input set for the graphical object 211 may be set according to the desired implementation.

Example implementations described herein are directed to implementing a transition state between the moving state and the placement state of the graphical object. The transition state contains a visual indicator on the display to indicate that a graphical object is undergoing a placement, along with a temporal indicator to indicate length of time until placement. In the example of FIG. 2(b), the visual indicator 212 is in the form of a timer with a bar indicating the time until expiration of the transition state 112. Although the visual indicator 212 is displayed on the graphical object 211, other implementations are also possible, depending on the desired implementation. For example, the visual indicator 212 may be displayed within the game screen, or outside of the game screen and next to an avatar or other graphic so that the user can refer to the indicator as needed. Further, the present disclosure is not limited to a bar timer for the visual indicator 212, and other visual indicators may be utilized depending on the desired implementation. Examples of other implementations can include the changing of the color or luminance of the graphical object 211, a display of a numerical timer on the screen, and so on depending on the desired implementation. By use of the visual indicator, the user is made aware that the graphical object is in the transition state and not yet in the placement state, which allows the user to make more accurate decisions for the displayed graphical object. Further, for situations where audio cues may not be available to indicate the placement state, the visual indicator allows the user to realize that the graphical object is not yet in the placement state, and can proceed accordingly. In desired implementations where time remaining in the transition state 112 is not to be displayed, the visual indicator can take the form of an indicator that does not reveal the time remaining, such as a color change, or an added graphic.

FIG. 2(c) illustrates an example game screen with the GUI set on the transition state 112, in accordance with an example implementation. In the example of FIG. 2(c), an input for rotation was received by the GUI through the device, so graphical object is rotated as shown at 211-2. The transition state 112 is maintained, and the visual indicator is reset in this example as shown at 212-2, with the timer bar being refilled to indicate that the time is reset. In example implementations, the timer for the transition state 112 can be reset upon receipt of certain inputs (e.g., rotation, lateral movement), so that the user may gain extra time to take the transition state into consideration. To prevent perpetual maintenance of the transition state 112, a counter can be utilized to count the number of inputs made to the graphical object. When the counter reaches a threshold, then the timer may continue without a reset, even after receiving input for movement. Depending on the desired implementation, the timer may continue without a reset for other situations as well (e.g., no possible movement left for the graphical object, graphical object reaches corner of the game screen, etc.). Thus, during the transition phase 112, input is directed by the GUI towards control of the graphical object in the transition state 112, whereupon when the graphical object is moved away from the placement location, the transition state may reset, and the temporal indicator may also reset to indicate the refreshed length of time until placement.

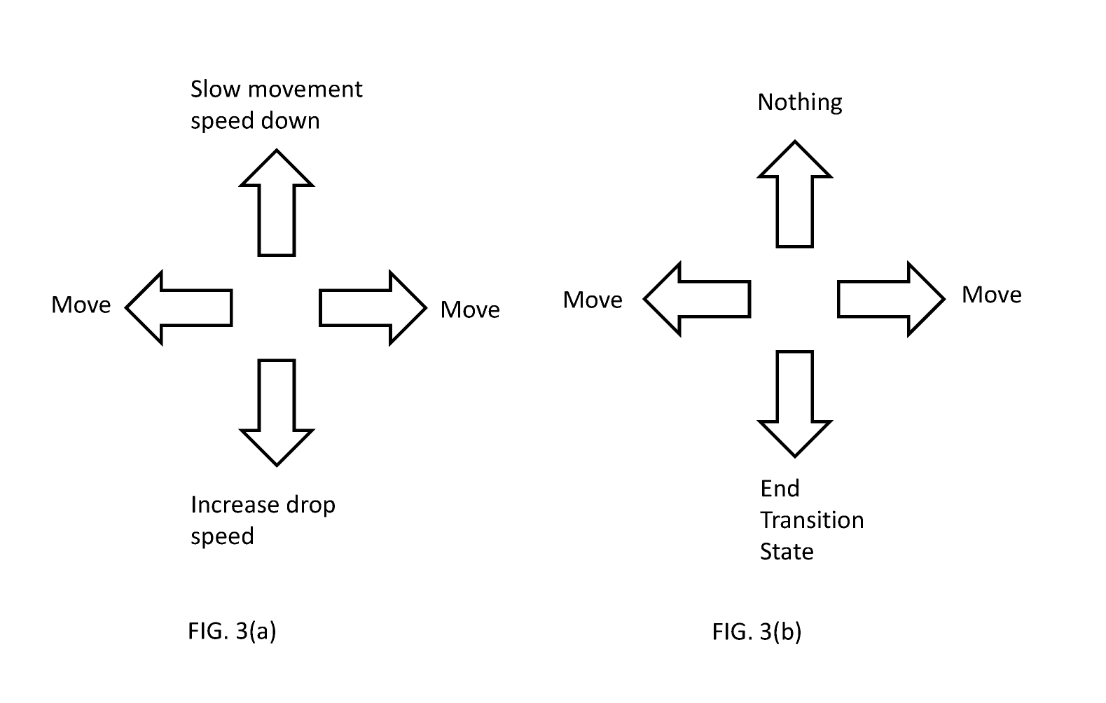

FIG. 3(a) illustrates example controls for a GUI during the moving state 111, in accordance with an example implementation. In this example, the input set for a game screen implementing falling graphical objects is shown, however, the input set can be changed according to the desired implementation and the present disclosure is not limited to this input set. In this example of the moving state 111, the up directional input causes the GUI to slow down the graphical object, the left and right directional inputs cause the GUI to move the graphical object in the corresponding direction, and the down directional input causes the graphical object to fall faster.

FIG. 3(b) illustrates example controls for a GUI during the transition state 112, in accordance with an example implementation. In this example, the input set for a game screen implementing falling graphical objects is shown, however, the input set can be changed according to the desired implementation and the present disclosure is not limited to this input set. When the GUI enters the transition state 112 for the graphical object, the input set is changed from the moving state 111. In this example for the transition state 112, the up directional input is disabled, the left and right directional input cause movement of the graphical object, and the down directional input causes the GUI to exit the transition state 112 and enter the placement state 113 to set the graphical object in place.

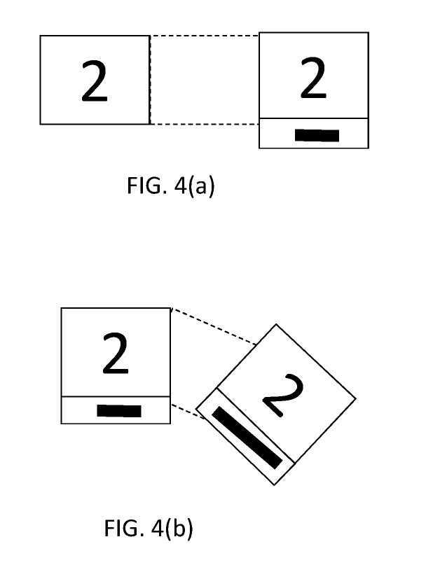

FIG. 4(a) illustrates an example movement of graphical objects for a touch screen in accordance with an example implementation. In the example as illustrated in FIG. 4(a), a drag or flick gesture is made on a graphical object displayed on a touch screen, which is dragged or flicked and then dropped to a different location as illustrated in FIG. 4(a), whereupon a visual indicator is displayed to indicate the time remaining for the transition state 112. In FIG. 4(b), while the graphical object is in the transition state 112, a twist gesture is made on the touch screen to rotate the graphical object, which causes the timer for the transition state 112 to reset as illustrated by the visual indicator on FIG. 4(b). The above examples may be modified in accordance with the desired implementation, such as different input sets for tap gestures and so on. Although the examples are directed to a touch screen, other implementations are also possible for gesture based inputs, and the present disclosure is not limited thereto. For example, devices to facilitate input of gestures based on head movement, eye tracking, and so on may also be utilized for inputs to the GUI as described in example implementations.

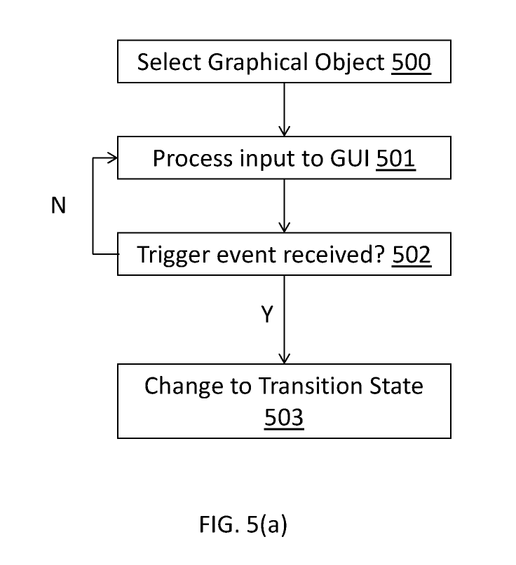

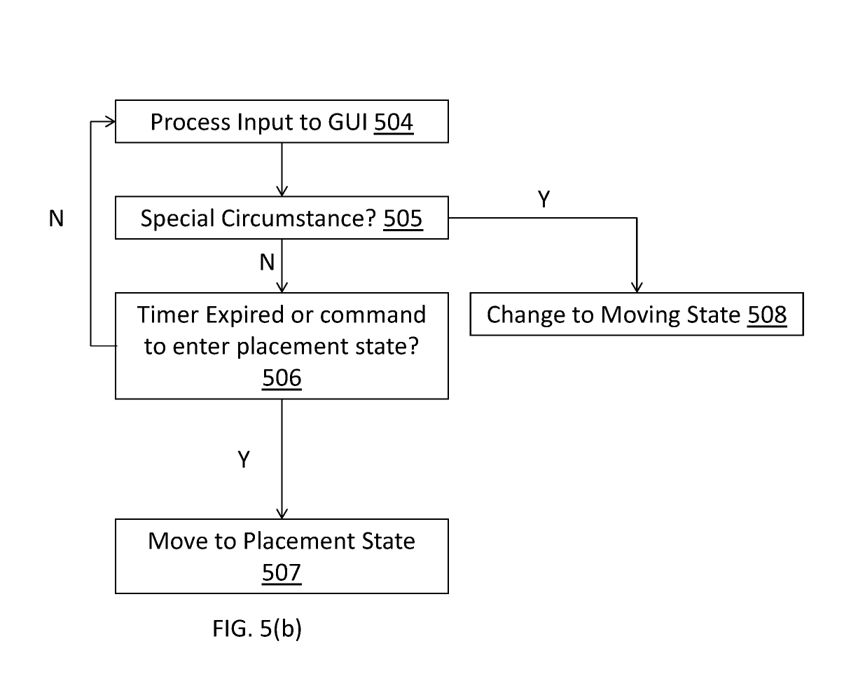

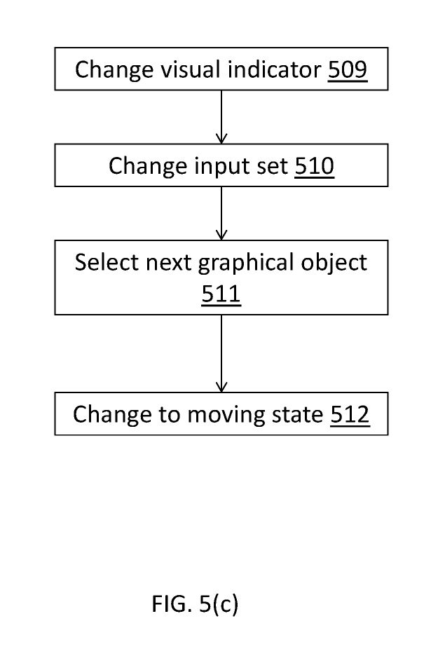

FIG. 5(a) illustrates the flow diagram for a moving state, in accordance with an example implementation. In FIG. 5(a), the GUI selects a graphical object at 500 at the initial portion of the moving state 111. The selection can be done as part of a game implementation (e.g., selecting the falling object in a game screen), as a selection based on a gesture or other input for a GUI, or other methods depending on the desired implementation. At 501, the GUI begins to process inputs made to the GUI. This can be based on the input set defined for the moving state 111 as illustrated in FIG. 3(a), or some other input set defined for the moving state 111 as defined according to the desired implementation. At 502, the GUI determines if a trigger event has been received. As described above, the trigger event can be the graphical object moving into another graphical object or the edge of a game screen, the end of a gesture, an instruction to directly enter the transition state, the moving graphical object coming into a complete stop, the moving graphical object being within a threshold distance from the edge of a game screen or another graphical object, and so on, depending on the desired implementation. If so (Y) then the moving state 111 transitions to the transition state 112 at 503. Otherwise (N), the flow proceeds back to 501.

FIG. 5(b) illustrates the flow diagram for a transition state 112, in accordance with an example implementation. The GUI at 504 begins to process inputs made to the GUI based on the input set defined for the transition state 112 as illustrated in FIG. 3(b), or some other input set defined for the transition state 112 as defined according to the desired implementation. At 505, the GUI determines if any special circumstances exist that would transition the GUI back to the moving state 111. The special circumstances, as described above, can include movement of the graphical object out of the way of the graphical object or the border of the game screen to facilitate additional movement, a gesture to revert back to the moving state, an instruction as part of a game mechanic or other circumstances in accordance of the desired implementation. If so (Y), the flow proceeds to 508 to transition back to the moving state 111. Otherwise (N), the flow proceeds to 506 wherein the GUI determines if the time remaining for the transition state 112 has expired, or if a command has been received to enter the placement state. An example of such a command is illustrated in FIG. 3(b), but can also include other commands such as the selection of another graphical object, depending on the desired implementation. If so (Y), then the flow proceeds to 507 to proceed to the placement state, wherein the graphical object is placed at the location, and the GUI selects another graphical object for processing in the moving state 111. Otherwise (N), the flow proceeds to the flow back to 505.

FIG. 5(c) illustrates the flow diagram for the placement state 113, in accordance with an example implementation. When a previously moving object is set in place from the transition state 112, the visual indicator is changed at 509 to indicate that placement is complete. Such change in the visual indicator can include partial or complete removal of the visual indicator, or changing the appearance of the graphical object to indicate that the object is placed, or according to another desired implementation. At 510, the input set is changed to the input set used for the moving state 111 (e.g. the input set is changed from the input set of FIG. 3(b) to the input set of FIG. 3(a)). At 511, the GUI may then change the selection to another graphical object, whereupon subsequent inputs are then directed to the new graphical object. At 512, the GUI may then transition to the moving state 111 to cause the graphical object to move.

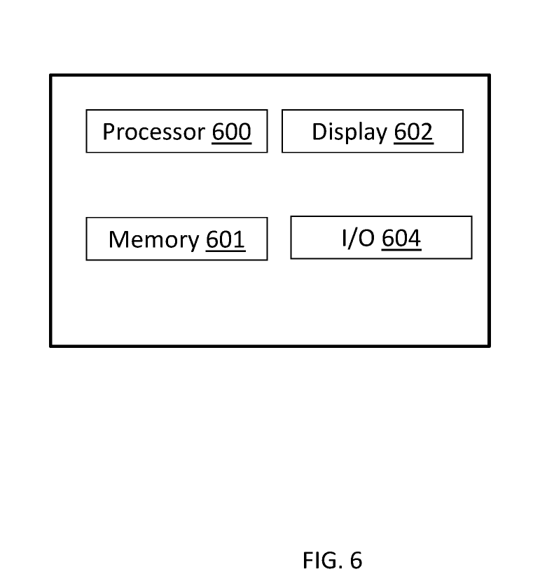

FIG. 6 illustrates an example computer diagram upon which example implementations may be implemented. The computer diagram may be implemented in any apparatus such as a laptop, a smart phone, a tablet, or other device that utilizes a GUI. The apparatus may include a processor 600, a display 601, a memory 602 and an I/O 603 for facilitating inputs. The processor 600 may be configured to provide a GUI through the display 601 and facilitate inputs through I/O 603. I/O 603 can include touch screen, keyboard, mouse, or other input devices depending on the desired implementation.

Processor 600 may be configured to display a visual indicator indicative of time remaining until placement of a previously moving graphical object as illustrated in FIGS. 2(b) and 2(c); change an input set of the Graphical User Interface (GUI) from a first set of inputs to a second set of inputs as illustrated in the change of input sets from FIGS. 3(a) to 3(b); and process one or more inputs directed at the previously moving graphical object based on the second set of inputs from FIG. 3(b). As illustrated in FIG. 5(b), for either one of expiration of the time remaining or for an input indicating placement of the graphical object according to the second set of inputs, processor 600 may set the graphical object in place and change the input set from the second set of inputs to the first set of inputs (from FIGS. 3(b) to 3(a) to transition back to the moving state 111). For input indicative of movement according to the second set of inputs, the processor 600 may be configured move the previously moving graphical object according to a limited motion ruleset as defined in memory 602 according to the desired implementation of the GUI.

Processor 600 may cause the display 601 to display the visual indicator. The visual indicator may be displayed responsive to the previously moving graphical object coming to a stop and before the previously moving graphical object is set in place, according to the desired implementation, by processor 600.

Processor 600 may be configured to, for input indicative of confirming placement of the graphical object according to the second set of inputs from FIG. 3(b), set the graphical object in place, change the visual indicator to indicate placement of the graphical object, change the second set of inputs to the first set of inputs, and select another graphical object for movement according to the first set of inputs as illustrated in the flow diagram of FIG. 5(c).

Processor 600 can also be configured to, for the moving of the previously moving graphical object causing the limited movement ruleset to no longer be applied based on how the limited movement ruleset is defined in the memory 602, change on display 601 the visual indicator to indicate limited movement ruleset is not applicable (e.g., remove the timer to indicate that the graphical object is back in the moving state 111, etc.), change the second set of inputs to the first set of inputs (e.g. from FIG. 3(b) back to FIG. 3(a)), and process one or more inputs to the previously moving graphical object based on the first set of inputs.

Processor 600 is also configured to, for the moving of the previously moving graphical object according to a limited motion ruleset and for a number of the one or more inputs directed at the previously moving graphical object based on the second set of inputs not exceeding a threshold, reset the time remaining until placement of the previously moving graphical object, and change, on the display 601, the visual indicator to indicate the resetting of the time remaining until placement of the previously moving graphical object (e.g., refilling the time bar, etc.). Processor 600 may be configured to, for the number of the one or more inputs directed at the previously moving graphical object based on the second set of inputs exceeding a threshold, cause the time remaining until placement of the previously moving graphical object to continue.

In an example implementation involving AR user interfaces, the example computer diagram can also include a camera for processing video feed. Processor 600 can be configured to overlay AR graphics or the AR GUI on the video feed and present the video feed with the AR overlaid elements on display 601. In such an example implementation, the graphical object can be moved based on the orientation of the camera and the device implementing the computer diagram. The graphical object can also be moved through gestures or other methods, depending on the desired implementation, and be facilitated through the flow diagram as illustrated in FIG. 1(b) and FIGS. 5(a) to 5(c). For example, the input to GUI 501 can be the orientation of the camera, which moves the AR objects in the camera feed relative to the position and orientation of the device.

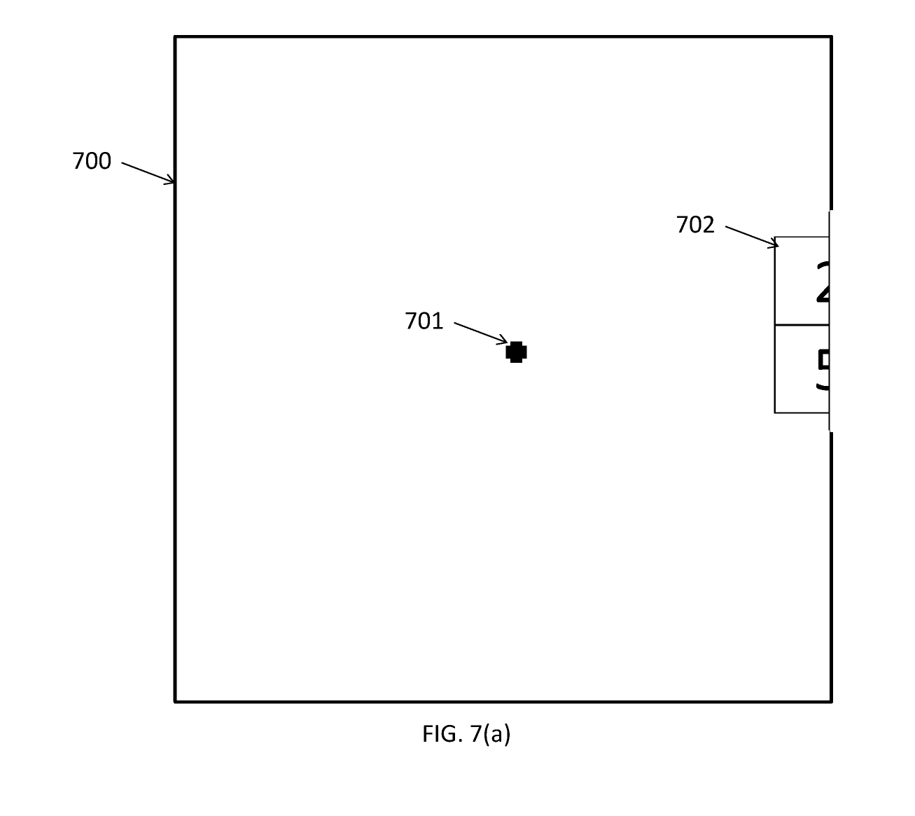

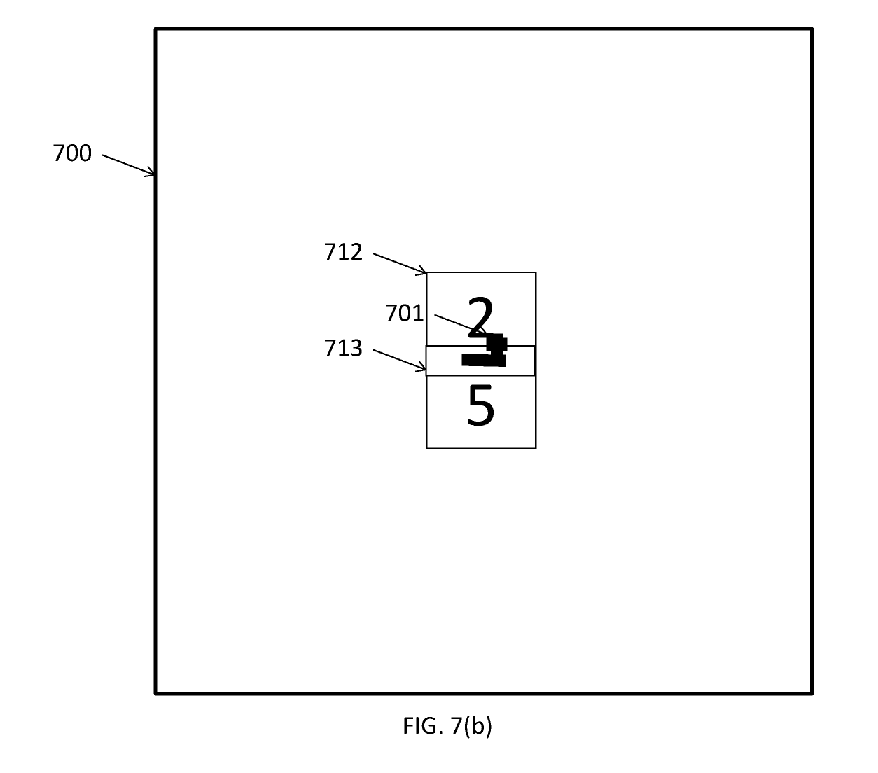

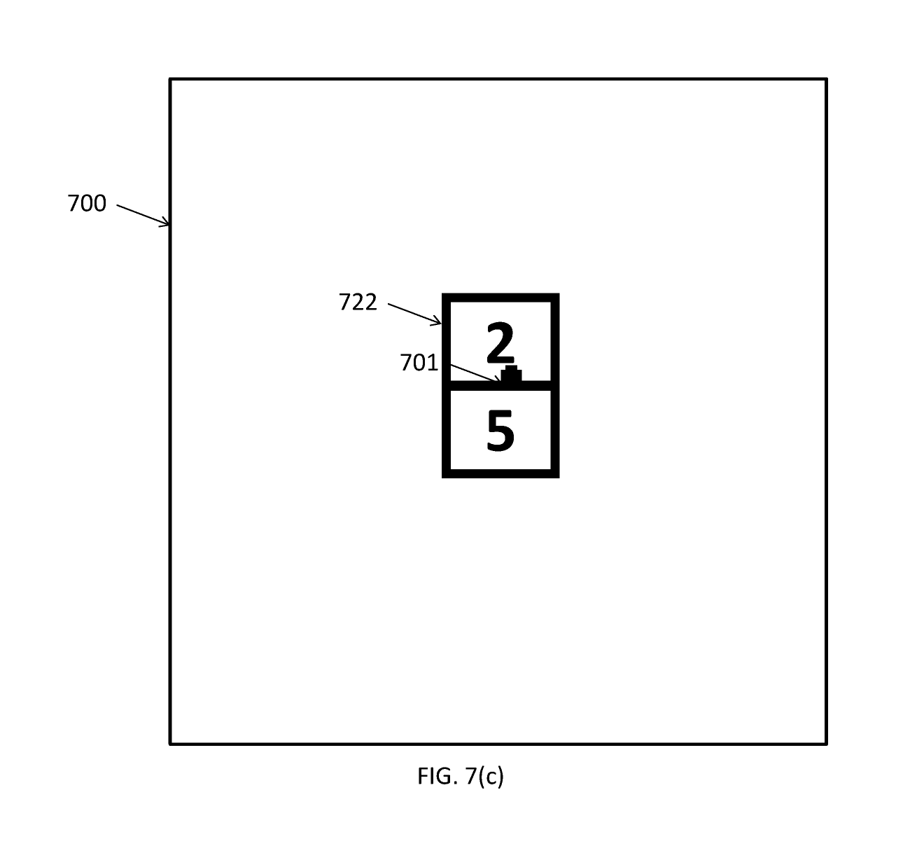

In an example implementation where a graphical object is selected through the use of an AR GUI, the object can be moved based on the orientation of the camera until the AR graphical object is centered or placed in a location for selection, where the location is defined in accordance with a desired implementation, as illustrated in FIGS. 7(a) to 7(c).

In an example implementation involving VR user interfaces, the example computer diagram can also include a headset or other wearable apparatus (e.g., glasses) for providing VR video feed. In such an example implementation, the graphical objects in the VR feed can be moved based on the orientation of the headset or other wearable apparatus (e.g. through user gaze or through user head orientation to move the object based on the field of vision of the user in the VR video feed) or through other methods (e.g. a controller), depending on the desired implementation. An example is illustrated in FIGS. 7(a) to 7(c). Similar algorithms as described in FIGS. 5(a) to 5(c) can be utilized to move the object in the VR video feed. For example, the input to GUI 501 can be the gaze of the user, or movement through a controller, or orientation of the head of the user, which moves the objects in the VR video feed relative to the position of the user in the VR world.

In an example implementation involving user gaze to select an object the processor 600 can be configured to display a visual indicator indicative of time remaining until placement of a previously moving graphical object (e.g. a VR object brought into a cursor or brought into the center of the user VR view through user gaze or head orientation), and change an input set of the Graphical User Interface (GUI) from a first set of inputs to a second set of inputs (e.g. providing an input set confirming a selection of an object or other interaction with the object), and process one or more inputs directed at the previously moving graphical object based on the second set of inputs (e.g., a gesture or other input as user is gazing at object). For either one of expiration of the time remaining or for an input indicating placement of the graphical object according to the second set of inputs, the processor 600 can set the graphical object in place and change the input set from the second set of inputs to the first set of inputs (e.g., select or interact with the object that the user is gazing at, and return to original input set), and wherein for input indicative of movement according to the second set of inputs, processor 600 move the previously moving graphical object according to a limited motion ruleset (e.g., limited interaction instructions with the object). Similar implementations may also be applied to AR objects overlaid on a camera feed.

In another example implementation, the methods described above can also be used to assist in AR and VR user interfaces. FIGS. 7(a) to 7(c) illustrate an example implementation involving VR interfaces. In an example view from a VR GUI 700 of FIG. 7(a), the desired object to be selected 702 is not centered into view. The center of the VR GUI 701 can be indicated by a graphic (e.g. crosshair) as shown at 701, however, such an indication is optional, and can also have no display of a cursor in accordance with a desired implementation. The user shifts the gaze of the VR GUI 700 until the cursor is placed on the object and a timer 713 appears in FIG. 7(b) once the objected is shifted and centered into view as shown as 712. Once the timer expires, the cursor is set on the object in FIG. 7(c) through a graphical indication as shown in 713, whereupon the object is deemed to be selected and the interface is thereby in the placement state. While the cursor is on the desired object to be selected and while the timer 713 is still active (e.g. interface shifted to the transition state), the input set can change to an alternate input set as described in FIGS. 5(a) to 5(c). For example, shifting of the gaze can be restricted until a button on another controller is pressed, or a gesture is made. In another example, the display can zoom in to indicate that the interface is in the transition state, wherein the cursor has be moved off screen to exit the transition state. Other variations of the above example implementations are also possible, and the present disclosure is not limited thereto.

Although the above example is directed to VR, similar implementations can also be applied to AR as well. Further, although the example implementation is directed to the center of the GUI, the present implementations are not limited thereto and variations can be utilized (e.g., based on user eye tracking, based on orientation of device, etc.), in accordance with a desired implementation Through the example implementation described above, it is thereby possible to select an object by shifting the view of the AR or VR GUI towards an object, which will be highlighted with a timer for selection as the gaze or center of the GUI is focused on the object, and then the selection cursor is set into place on the object after the expiration of the timer.

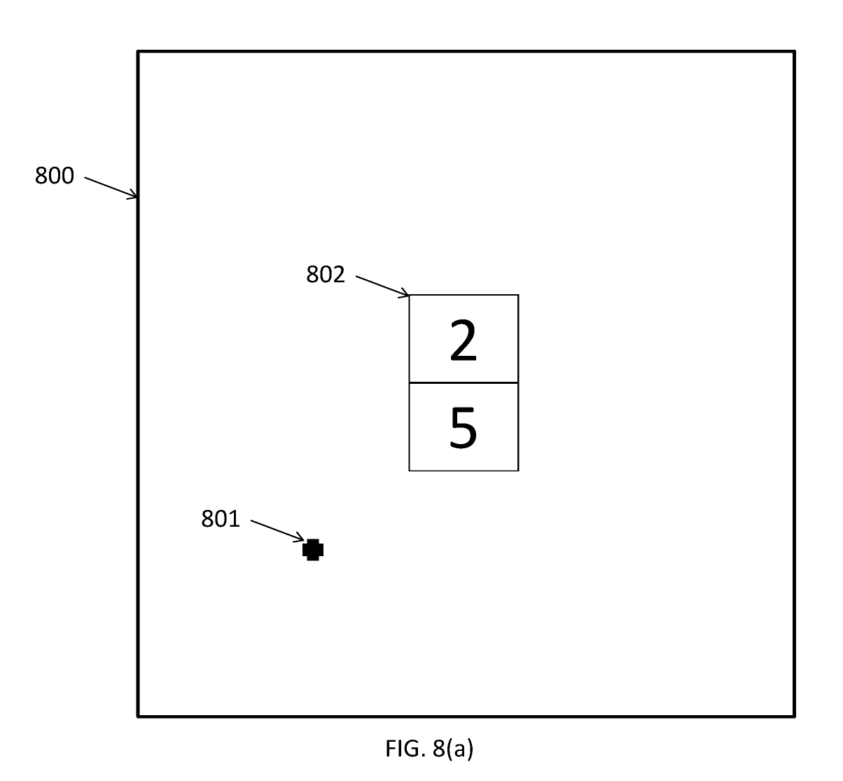

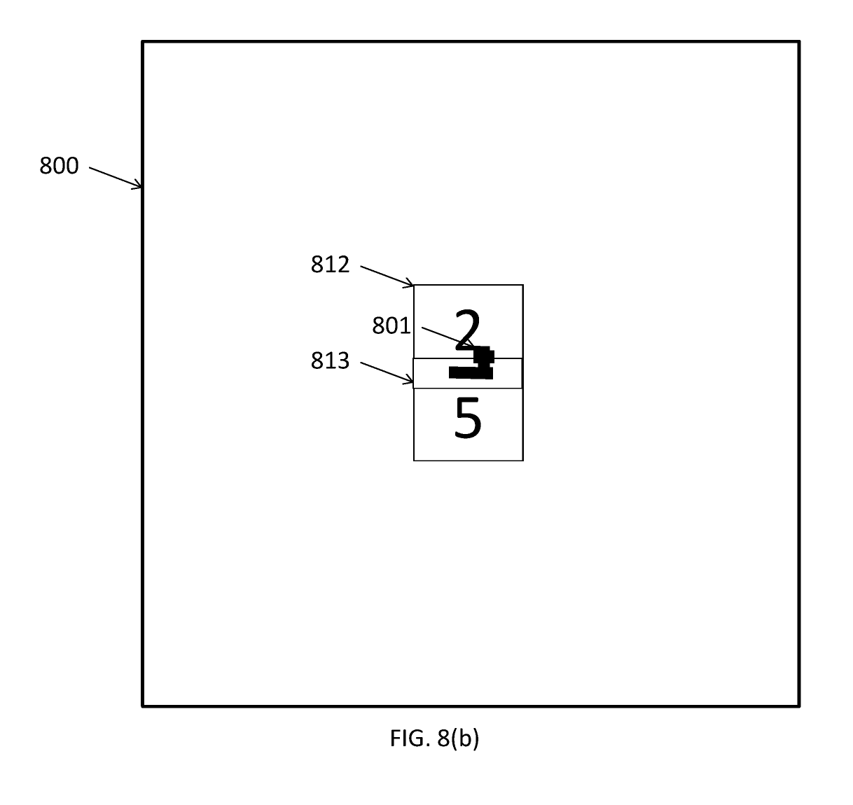

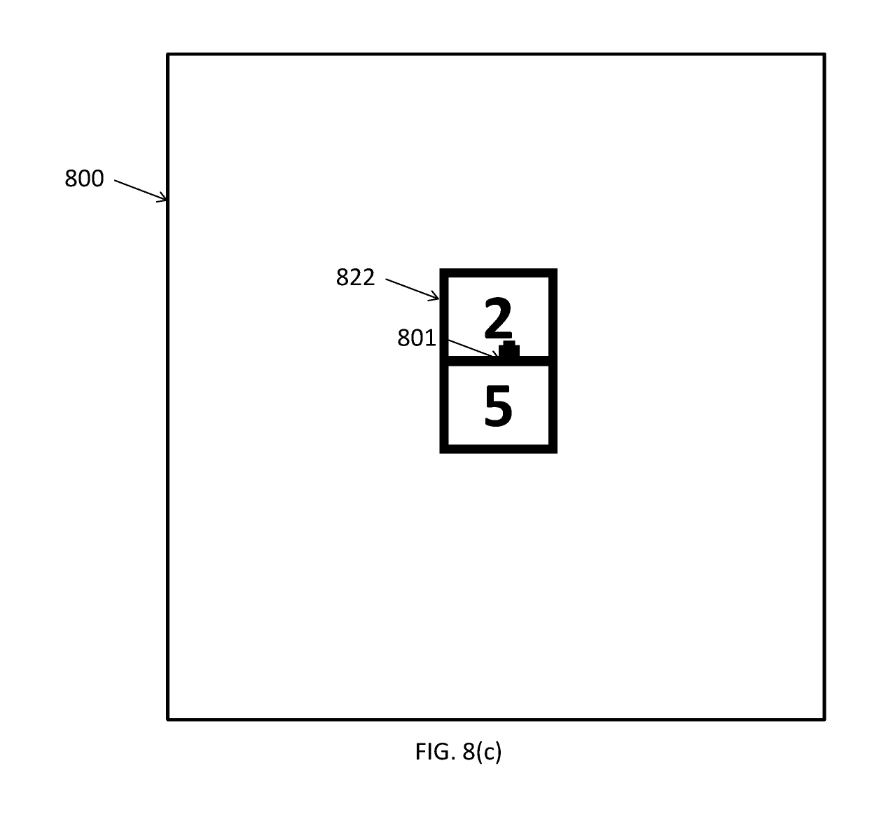

In another example implementation, the methods described above can also be used to assist in AR and VR user interfaces. FIGS. 8(a) to 8(c) illustrate an example cursor implementation through the use of a controller or other selection means. In an example involving a game controller cursor on a game console GUI 800 of FIG. 8(a), the desired object to be selected 802 is not selected by the cursor. The game controller cursor 801 can be indicated by a graphic (e.g. crosshair, mouse cursor, etc.) as shown at 801, however, such an indication is optional, and a cursor may also not be displayed in accordance with a desired implementation. The user moves the cursor 801 onto the object as shown at 812 until the timer 813 appears as shown at FIG. 8(b). Once the timer expires, the object is selected as shown in FIG. 8(c) through a graphical indication as shown in 813. While the cursor is on the desired object to be selected and while the timer 813 is still active (e.g. interface shifted to the transition state), the input set can change to an alternate input set as described in FIGS. 5(a) to 5(c). For example, the cursor can be restricted by movement to only be within the boundaries of the object until a button on the controller is pressed or a gesture is made. In another example, the display can zoom in to indicate that the interface is in the transition state, wherein the cursor has be moved off screen to exit the transition state. In another example, the transition state can only be entered when a button is pressed and held, or when a finger or stylus is placed on a certain location, whereupon the cursor can be locked in until the timer 813 has expired. In another example, the transition state is entered when a button is pressed and held, and exited when the cursor is moved away from the object or if the button is no longer held. Other variations of the above example implementations are also possible, and the present disclosure is not limited thereto. Although the above example is directed to a game console, similar implementations can also be applied to computer interfaces, VR interfaces, and so on depending on the desired implementation. Further, although the example implementation is directed to the use of a game controller to control a cursor, other input devices (e.g., mouse, finger, stylus, etc.) can also be utilized, depending on the desired implementation.

The example implementations of FIGS. 7(a) to 7(c) and 8(a) to 8(c) can also be applied to other devices (e.g., mouse, stylus, trackpad, etc.) to assist in cursor placement for situations where the selection area for an object is only a few pixels wide, or when audio confirmation of an object selection is not available. In an example implementation involving a mouse cursor operated by a mouse, a stylus or other means, the moving cursor can be brought to rest on an object and then another command (e.g. button press, gesture) is entered to enter the object in the transition state. During this time, a graphical display can be utilized to indicate that the object is in the transition state (e.g. a timer), and the transition state can be maintained while the other command is maintained (e.g., holding a button to maintain transition state, releasing a button to exit transition state). In such an example implementation, the operator of the cursor can thereby confirm the object being selected, and can maintain the cursor and the button press until the timer or other graphical display indicates that enough time has elapsed for an object to be selected, or for some other command or instruction associated with the object to be executed.

In such example implementations, processor 600 of FIG. 6 can be configured to display a visual indicator indicative of time remaining until selection of a graphical object by a previously moving cursor in a graphical user interface (GUI) as shown in FIGS. 7(a) to 7(c) and 8(a) to 8(c); change an input set of the GUI from a first set of inputs to a second set of inputs; process one or more inputs to the GUI based on the second set of inputs; and for either one of expiration of the time remaining or for an input received to select of the graphical object according to the second set of inputs, selecting the object and changing the input set from the second set of inputs to the first set of inputs. The selection of the object can be effected through invoking a command at the object (e.g. selection, deletion, rotation, and so on) In example implementations, the visual indicator can be displayed responsive to the previously moving cursor being placed within the graphical object. The visual indicator can also be displayed responsive to the previously moving cursor being placed within the graphical object and another processed input according to the second set of inputs. The another processed input can also be at least one of one of a held mouse button press, a held controller button press, a held stylus press on a touch screen, a held keypress, and a held finger press on a touch screen, depending on the desired input apparatus (e.g. keyboard, mouse, stylus, trackpad, game controller, remote controller, touchpad, and so on).

For the input indicative selection of the graphical object according to the second set of inputs, processor 600 of FIG. 6 may be configured to select the object, change the visual indicator to indicate selection of the graphical object, and change the second set of inputs to the first set of inputs. Selection of the object can be conducted through invoking a command at the object (e.g. selection, deletion, rotation, and so on depending on the desired implementation).

For an input received to change from the second set of inputs to the first set of inputs, processor 600 of FIG. 6 may be configured to remove the visual indicator, change the second set of inputs to the first set of inputs, and process one or more inputs to the previously moving cursor based on the first set of inputs.

In example implementations, the cursor can be configured to move based on a gaze from a virtual reality (VR) headset, a stylus for touch screen, a mouse, a trackpad, or through other apparatuses depending on the desired implementation.

In example implementations, for VR the visual indicator may at least one of a changing a color of the graphical object and a display of a timer; wherein for the gaze being moved away from the graphical object before expiration of the time remaining, processor 600 is configured to not select the object and change the input set of the GUI from the second set of inputs to the first set of inputs; and wherein for the gaze being maintained within the graphical object until at least the expiration of the time remaining and for the cursor being within the object until at least the expiration of the time remaining, processor 600 is configured to select the graphical object and changing the input set of the GUI from the second set of inputs to the first set of inputs.

In example implementations the cursor may also not be displayed, which can be useful for interfaces for VR and AR. Further, the cursor can be configured to move based on a movement of a mouse, wherein the visual indicator is displayed responsive to the previously moving cursor being placed within the graphical object and a held mouse button press; wherein for the held mouse button press being released before expiration of the time remaining or for the cursor being moved outside of the graphical object, processor 600 can be configured to not select the object and changing the input set of the GUI from the second set of inputs to the first set of inputs; and wherein for the held mouse button press being held until at least the expiration of the time remaining and for the cursor being within the object until at least the expiration of the time remaining, processor 600 can be configured to select the graphical object and change the input set of the GUI from the second set of inputs to the first set of inputs. The selection of the graphical object can involve invoking a command at the object (e.g. selection, movement, rotation, deletion, etc. depending on the desired implementation). Further, in example implementations the visual indicator may involve a zoom in display of the graphical object.

In example implementations, the graphical objects can be augmented reality (AR) objects, and the cursor can be configured to move based on an input to a touch screen.

In example implementations, processor 600 can be configured to display a visual indicator indicative of time remaining until selection of a graphical object by a previously moving cursor in a graphical user interface (GUI); change an input set of the GUI from a first set of inputs to a second set of inputs; process one or more inputs to the GUI based on the second set of inputs; and for either one of expiration of the time remaining or for an input received to select of the graphical object according to the second set of inputs, select the object and changing the input set from the second set of inputs to the first set of inputs. In such an example implementation, the cursor can be configured to move based on a movement of a mouse, wherein the visual indicator is displayed responsive to the previously moving cursor being placed within the graphical object and a held mouse button press; wherein for the held mouse button press being released before expiration of the time remaining or for the cursor being moved outside of the graphical object, processor 600 is configured to not select the object and change the input set of the GUI from the second set of inputs to the first set of inputs; wherein for the held mouse button press being held until at least the expiration of the time remaining and for the cursor being within the object until at least the expiration of the time remaining, processor 600 is configured to select the graphical object and changing the input set of the GUI from the second set of inputs to the first set of inputs. The selection of the graphical object can involve invoking a command at the object (e.g. selection, movement, rotation, deletion, etc. depending on the desired implementation).

In example implementations, the cursor is configured to move based on a gaze from a virtual reality (VR) headset, wherein the visual indicator can include at least one of a changing a color of the graphical object and a display of a timer; wherein for the gaze being moved away from the graphical object before expiration of the time remaining, processor 600 is configured to not select the object and change the input set of the GUI from the second set of inputs to the first set of inputs; wherein for the gaze being maintained within the graphical object until at least the expiration of the time remaining and for the cursor being within the object until at least the expiration of the time remaining, processor 600 is configured to select the graphical object and changing the input set of the GUI from the second set of inputs to the first set of inputs. The selection of the graphical object can involve invoking a command at the object (e.g. selection, movement, rotation, deletion, etc. depending on the desired implementation).

In example implementations extended into free space implementations (e.g. 3D projections, holographic displays, holograms), processor 600 can be configured to display a visual indicator indicative of time remaining until selection of a graphical object by a previously moving cursor in a graphical user interface (GUI) in free space; change an input set of the GUI from a first set of inputs to a second set of inputs; process one or more inputs to the GUI based on the second set of inputs; and for either one of expiration of the time remaining or for an input received to select of the graphical object in free space according to the second set of inputs, select the object in free space and changing the input set from the second set of inputs to the first set of inputs. In such an example implementation, the cursor can be configured to move based on a gesture in free space or by movement of a hand or other body part in free space, wherein the visual indicator is displayed responsive to the previously moving cursor being placed within the graphical object in free space; wherein for the cursor in free space being moved outside of the graphical object in free space, processor 600 is configured to not select the object and change the input set of the GUI from the second set of inputs to the first set of inputs; wherein for the cursor in free space being within the graphical object in free space until at least the expiration of the time remaining, processor 600 is configured to select the graphical object and changing the input set of the GUI from the second set of inputs to the first set of inputs. The selection of the graphical object can involve invoking a command at the object (e.g. selection, movement, rotation, deletion, etc. depending on the desired implementation).

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A non-transitory computer readable medium, storing instructions for executing a process, the instructions comprising:
displaying a visual indicator indicative of time remaining until placement of a previously moving graphical object in a graphical user interface (GUI);
changing an input set of the GUI from a first set of inputs to a second set of inputs;
processing one or more inputs directed at the previously moving graphical object based on the second set of inputs;
for either one of expiration of the time remaining or for a received input for placement of the graphical object according to the second set of inputs, setting the graphical object in place and changing the input set from the second set of inputs to the first set of inputs;
for a received input indicative of movement according to the second set of inputs, moving the previously moving graphical object according to a limited motion ruleset.

2. The non-transitory computer readable medium of claim 1, wherein the visual indicator is displayed responsive to the previously moving graphical object coming to a stop and before the previously moving graphical object is set in place.

3. The non-transitory computer readable medium of claim 1, wherein the instructions further comprise, for input indicative of confirming placement of the graphical object according to the second set of inputs, setting the graphical object in place, changing the visual indicator to indicate placement of the graphical object, changing the second set of inputs to the first set of inputs, and select another graphical object for movement according to the first set of inputs.

4. The non-transitory computer readable medium of claim 1, wherein the instructions further comprise, for the moving of the previously moving graphical object causing the limited movement ruleset to no longer be applied, changing the visual indicator to indicate limited movement ruleset is not applicable, changing the second set of inputs to the first set of inputs, and processing one or more inputs to the previously moving graphical object based on the first set of inputs.

5. The non-transitory computer readable medium of claim 1, wherein the instructions further comprise, for the moving of the previously moving graphical object according to a limited motion ruleset and for a number of the one or more inputs directed at the previously moving graphical object based on the second set of inputs not exceeding a threshold, resetting the time remaining until placement of the previously moving graphical object, and changing the resetting of the time remaining until placement of the previously moving graphical object;
for the number of the one or more inputs directed at the previously moving graphical object based on the second set of inputs exceeding a threshold, causing the time remaining until placement of the previously moving graphical object to continue.

6. A non-transitory computer readable medium, storing instructions for executing a process, the instructions comprising:
displaying a visual indicator indicative of time remaining until selection of a graphical object by a previously moving cursor in a graphical user interface (GUI);
changing an input set of the GUI from a first set of inputs to a second set of inputs;
processing one or more inputs to the GUI based on the second set of inputs;
for either one of expiration of the time remaining or for an input received to select of the graphical object according to the second set of inputs, selecting the object and changing the input set from the second set of inputs to the first set of inputs.

7. The non-transitory computer readable medium of claim 6, wherein the visual indicator is displayed responsive to the previously moving cursor being placed within the graphical object.

8. The non-transitory computer readable medium of claim 6, wherein the visual indicator is displayed responsive to the previously moving cursor being placed within the graphical object and another processed input according to the second set of inputs.

9. The non-transitory computer readable medium of claim 8, wherein the another processed input is at least one of one of a held mouse button press, a held controller button press, a held stylus press on a touch screen, a held keypress, and a held finger press on a touch screen.

10. The non-transitory computer readable medium of claim 6, wherein the instructions further comprise, for the input indicative selection of the graphical object according to the second set of inputs, selecting the object, changing the visual indicator to indicate selection of the graphical object, and changing the second set of inputs to the first set of inputs.

11. The non-transitory computer readable medium of claim 6, wherein the instructions further comprise, for an input received to change from the second set of inputs to the first set of inputs, removing the visual indicator, changing the second set of inputs to the first set of inputs, and processing one or more inputs to the previously moving cursor based on the first set of inputs.

12. The non-transitory computer readable medium of claim 6, wherein the cursor is configured to move based on a gaze from a virtual reality (VR) headset.

13. The non-transitory computer readable medium of claim 12, wherein the visual indicator comprises at least one of a changing a color of the graphical object and a display of a timer;
wherein for the gaze being moved away from the graphical object before expiration of the time remaining, not selecting the object and changing the input set of the GUI from the second set of inputs to the first set of inputs;
wherein for the gaze being maintained within the graphical object until at least the expiration of the time remaining and for the cursor being within the object until at least the expiration of the time remaining, selecting the graphical object and changing the input set of the GUI from the second set of inputs to the first set of inputs.

14. The non-transitory computer readable medium of claim 12, wherein the cursor is not displayed.

15. The non-transitory computer readable medium of claim 6, wherein the cursor is configured to move based on a movement of a mouse, wherein the visual indicator is displayed responsive to the previously moving cursor being placed within the graphical object and a held mouse button press;
wherein for the held mouse button press being released before expiration of the time remaining or for the cursor being moved outside of the graphical object, not selecting the object and changing the input set of the GUI from the second set of inputs to the first set of inputs;
wherein for the held mouse button press being held until at least the expiration of the time remaining and for the cursor being within the object until at least the expiration of the time remaining, selecting the graphical object and changing the input set of the GUI from the second set of inputs to the first set of inputs.

16. The non-transitory computer readable medium of claim 6, wherein the visual indicator comprises a zoom in display of the graphical object.

17. The non-transitory computer readable medium of claim 6, wherein the graphical objects are augmented reality (AR) objects, and wherein the cursor is configured to move based on an input to a touch screen.

18. A method, comprising:
displaying a visual indicator indicative of time remaining until selection of a graphical object by a previously moving cursor in a graphical user interface (GUI);
changing an input set of the GUI from a first set of inputs to a second set of inputs;
processing one or more inputs to the GUI based on the second set of inputs;
for either one of expiration of the time remaining or for an input received to select of the graphical object according to the second set of inputs, selecting the object and changing the input set from the second set of inputs to the first set of inputs.

19. The method of claim 18, wherein the cursor is configured to move based on a movement of a mouse, wherein the visual indicator is displayed responsive to the previously moving cursor being placed within the graphical object and a held mouse button press;
wherein for the held mouse button press being released before expiration of the time remaining or for the cursor being moved outside of the graphical object, not selecting the object and changing the input set of the GUI from the second set of inputs to the first set of inputs;
wherein for the held mouse button press being held until at least the expiration of the time remaining and for the cursor being within the object until at least the expiration of the time remaining, selecting the graphical object and changing the input set of the GUI from the second set of inputs to the first set of inputs.

20. The method of claim 18, wherein the cursor is configured to move based on a gaze from a virtual reality (VR) headset, wherein the visual indicator comprises at least one of a changing a color of the graphical object and a display of a timer;
wherein for the gaze being moved away from the graphical object before expiration of the time remaining, not selecting the object and changing the input set of the GUI from the second set of inputs to the first set of inputs;
wherein for the gaze being maintained within the graphical object until at least the expiration of the time remaining and for the cursor being within the object until at least the expiration of the time remaining, selecting the graphical object and changing the input set of the GUI from the second set of inputs to the first set of inputs.
